(19) United States
(12) Patent Application Publication
(10) Pub. No.: US 2026/0075460 A1
(43) Pub. Date: Mar. 12, 2026

(54) METHOD AND SYSTEM OF UNIFIED BUFFER AND DELAY STATUS REPORTING FOR UPLINK SCHEDULING IN 5G NR

(71) Applicant: INDIAN INSTITUTE OF TECHNOLOGY KHARAGPUR, Kharagpur (IN)

(72) Inventors: Moyukh Laha, Kharagpur (IN); Goutam Das, Kharagpur (IN)

(73) Assignee: INDIAN INSTITUTE OF TECHNOLOGY KHARAGPUR, Kharagpur, WB (IN)

(21) Appl. No.: 19/022,994

(22) Filed: Jan. 15, 2025

(30) Foreign Application Priority Data
Sep. 9, 2024 (IN) 202431068060

(51) Int. Cl. H04W 28/02; H04W 72/21; H04W 76/38

(52) U.S. Cl. CPC H04W 28/0278; H04W 72/21; H04W 76/38

(57) ABSTRACT

The present invention relates to the Buffer and Delay Status Reporting (BDSR) mechanism which is an innovative system designed to enhance uplink scheduling and resource allocation in next-generation wireless networks by unifying Buffer Status Reports (BSRs) and Delay Status Reports (DSRs) into a single reporting framework, thus eliminating redundant signaling and reduces overhead. Further, the mechanism features adaptive triggering based on data availability and delay thresholds, and it offers flexible reporting formats to optimize radio resource use. These advancements enable more accurate and efficient network performance, particularly in supporting delay-sensitive applications with diverse quality of service requirements.

### RELATED APPLICATIONS

This application claims priority to India patent application No. 202431068060, Filing Date Sep. 9, 2024, entitled METHOD AND SYSTEM OF UNIFIED BUFFER AND DELAY STATUS REPORTING FOR UPLINK SCHEDULING IN 5G NR; which is incorporated herein by reference in its entirety.

### FIELD OF THE INVENTION

The present invention relates to the Buffer and Delay Status Reporting (BDSR) mechanism which is an innovative system designed to enhance uplink scheduling and resource allocation in next-generation wireless networks by unifying Buffer Status Reports (BSRs) and Delay Status Reports (DSRs) into a single reporting framework, thus eliminating redundant signaling and reduces overhead. Further, the mechanism features adaptive triggering based on data availability and delay thresholds, and it offers flexible reporting formats to optimize radio resource use. These advancements enable more accurate and efficient network performance, particularly in supporting delay-sensitive applications with diverse quality of service requirements.

### BACKGROUND OF THE INVENTION

Buffer Status Reports (BSRs) and Delay Status Reports (DSRs) serve as foundational mechanisms within 5G networks, playing a critical role in radio resource allocation and latency management. The 3GPP TS 38.321 specification delineates BSRs as reporting tools for the buffer status of Logical Channel Groups (LCGs), whereas DSRs are employed to convey delay-critical data specifically for configured LCGs. Innovations in these reporting mechanisms have been extensively pursued to optimize network performance and minimize latency. Significant advancements have been made in enhancing the functionality of BSR mechanisms. For instance, the enhanced BSR (eBSR) mechanism utilizes predictive estimation to mitigate uplink latency and jitter, providing a more responsive communication environment [1]. Additionally, modifications to the BSR mechanism, including the integration of “Happy bits” within the MAC BSR control elements, have been proposed to improve the accuracy of feedback, which is critical for adaptive network operations [2]. In vehicular 5G networks, buffer-aware streaming methods have been developed to sustain service quality during handover events [4, 5]. Moreover, integrating buffer status with Proportional Fair (PF) scheduling has been explored to better support enhanced mobile broadband (eMBB) services, thereby improving overall throughput and fairness in resource allocation [6]. The quest to reduce signaling overhead without compromising performance has led to the introduction of low-overhead buffer level signaling techniques [7]. Concurrently, dynamic buffer sizing and pacing strategies have been suggested to counteract buffer bloat and facilitate the delivery of low-latency services, ensuring the network's responsiveness under various traffic conditions [3].

The ongoing innovation in BSR mechanisms is further reflected in the patent landscape. Intel Corporation's patent (JP6022019B2) addresses methods for delay reduction in LTE Radio Access Networks, underscoring the significance of timely data transmission [8]. Another notable patent by Hong and Lee (U.S. Pat. No. 11,832,125B2) introduces a novel approach for transmitting BSRs in small cell environments, which is crucial for the scalability and adaptability of network architectures [9]. Additionally, the patent by Tesanovic and Baker (U.S. Pat. No. 11,882,428B2) presents an adaptable BSR mechanism designed to facilitate flexible communication across varying network conditions, demonstrating the industry's commitment to evolving BSR functionality [10].

### LITERATURE SEARCH RELATING TO THIS INVENTION

[1] F. Ronteix-Jacquet, X. Lagrange, I. Hamchaoui, and A. Ferrieux, “Rethinking Buffer Status Estimation to Improve Radio Resource Utilization in Cellular Networks,” in 2022 IEEE 95th Vehicular Technology Conference: (VTC2022-Spring), 2022, pp. 1-5.
[2] S. Lin and J. Yu, “Happy Bits Based BSR Mechanism in 5G Networks,” IOP Conference Series: Materials Science and Engineering, vol. 466, 2018.
[3] M. Irazabal, E. López-Aguilera, I. Demirkol, and N. Nikaein, “Dynamic Buffer Sizing and Pacing as Enablers of 5G Low-Latency Services,” IEEE Transactions on Mobile Computing, vol. 21, pp. 926-939, 2022.
[4] C. Lai, Y. Chang, H. Chao, M. S. Hossain, and A. Ghoneim, “A Buffer-Aware QoS Streaming Approach for SDN-Enabled 5G Vehicular Networks,” IEEE Communications Magazine, vol. 55, pp. 68-73, 2017.
[5] C. Lai, R. Hwang, H. Chao, M. M. Hassan, and A. Alamri, “A buffer-aware HTTP live streaming approach for SDN-enabled 5G wireless networks,” IEEE Network, vol. 29, pp. 49-55, 2015.
[6] A. Mamane, M. Fattah, M. E. Ghazi, Y. Balboul, M. Bekkali, and S. Mazer, “Proportional fair buffer scheduling algorithm for 5G enhanced mobile broadband,” International Journal of Electrical and Computer Engineering, vol. 11, pp. 4165-4173, 2021.
[7] M. Tesanovic, M. Baker, and T. Moulsley, “Low-overhead buffer level signalling using weighted prioritisation,” Electronics Letters, vol. 45, pp. 1351-1352, 2009.
[8] Intel Corp., “User equipment and method for reducing delay in a radio access network,” JP Patent 6022019B2, 2016.
[9] S. Hong and K. Lee, “Method for transmitting buffer status report of terminal in small cell environment and device therefor,” U.S. Pat. No. 11,832,125B2, 2023.
[10] M. Tesanovic and M. P. J. Baker, “Communicating in a network using an adaptable buffer status report (BSR),” U.S. Pat. No. 11,882,428B2, 2023.

Traversing the prior arts, it was learned that very limited measures have been taken to develop a system unifying the Buffer and Delay Status Reporting (BDSR) mechanism, fabricated in the system to optimize uplink scheduling and resource allocation in wireless networks.

### OBJECT OF THE INVENTION

Primary objective of the present invention is to develop a system integrating Buffer Status Reports (BSRs) and Delay Status Reports (DSRs) into a single, cohesive framework, thereby eliminating redundant signaling, and significantly reducing overhead and improving network efficiency.

Another objective of the present invention is to develop an adaptive triggering feature which ensures that reports are generated only when necessary, optimizing resource usage and further minimizing unnecessary transmissions

### SUMMARY OF THE INVENTION

Thus, according to the basic aspect of the present invention there is provided a system for integrated single framework Buffer and Delay Status Reporting in wireless network-based communication comprising:
a user equipment (UE) configured to generate said integrated single framework Buffer and Delay Status Reports (BDSRs) in MAC layer;
MAC Processor in the UE configured to generate the BDSRs based on triggering logic and implementing adaptive triggering based on anyone or more of (i) regular BDSR trigger, (ii) delay-based trigger, (iii), padding-based trigger, (iv) retransmission-based trigger and (v) periodic trigger;
timer to support real-time comparisons with remaining time threshold, enabling precise delay-based triggering;
network node cooperative to said UE for adjustments in buffer management to enable unified reporting across Logical Channel Group (LCG) configured for the BDSRs.

In a preferred embodiment of the above system, the MAC Processor implements the regular BDSR trigger when uplink (UL) data in the wireless network-based communication becomes available for a logical channel belonging to a Logical Channel Group (LCG) configured for the BDSR, and either this UL data belongs to a logical channel with higher priority than any logical channel containing available UL data in any LCG or none of the logical channels belonging to any LCG contains available UL data;
wherein the MAC Processor implements the delay-based trigger when smallest remaining value of running PDCP (Packet Data Convergence Protocol) discard timers among all SDUs (Service Data Units) buffered for an LCG configured for the BDSR becomes less than the remaining time threshold, and there is no BDSR pending for this LCG;
wherein the MAC Processor implements the padding-based trigger when UL resources are allocated, and the number of padding bits is equal to or larger than the size of the BDSR MAC CE (Medium Access Control Element) plus its sub header;
wherein the MAC Processor implements the retransmission-based trigger when retx BDSR-timer expires, and at least one of the logical channels belonging to an LCG configured for BDSR contains UL data; and wherein the MAC Processor implements the periodic trigger when the periodic BDSR-timer expires.

In a preferred embodiment of the above system, the BDSR includes a short format or a long format or a truncated format to cater to different reporting needs and resource availability.

In a preferred embodiment of the above system, the BDSR format includes
Format indicator which indicates whether the BDSR is in short (0) or long/truncated (1) format;
LCG ID that identifies the specific Logical Channel Group being reported;
buffer size that represents the total amount of data available for the corresponding LCG;
remaining time that indicates the shortest remaining value of running PDCP discard Timer among all SDUs buffered for the LCG;
LCG indicators which is a bitmap where each bit corresponds to an LCG, indicating which LCGs are reported in the BDSR;
number of LCGs which specifies the number of LCGs reported in the BDSR;
BT (Buffer Table) which indicates which buffer size table is used for interpreting the Buffer Size field.

In a preferred embodiment of the above system, the MAC layer determines the appropriate BDSR format based on the number of LCGs to report and available UL resources, whereby for long and truncated formats, the LCGs are reported in ascending order of the LCG ID.

In a preferred embodiment of the above system, the MAC layer instructs Multiplexing and Assembly procedure to generate BDSR MAC CE which corresponds to BDSR-buffer and delay status report generated as a control element (CE) at the MAC layer for transmission, if UL-SCH (Uplink Shared Channel) resources are available and can accommodate the BDSR MAC CE plus its sub header and if resources are not available, then a scheduling request is triggered;
wherein the triggered BDSRs are cancelled when the UL grant can accommodate all pending data but not the BDSR MAC CE and a MAC PDU is transmitted including a Long BDSR MAC CE containing buffer status up to the last triggering event.

According to a further aspect in the present invention there is provided a method for enhancing uplink scheduling and resource allocation in a wireless network involving the above system comprising:
receiving data for one or more logical channel groups (LCGs) configured for said BDSR;
triggering the generation of a particular BDSR based on the triggering conditions, including:
   a regular BDSR trigger based on the availability of uplink (UL) data for a logical channel of an LCG;
   a delay-based trigger when the smallest remaining time of a Packet Data Convergence Protocol (PDCP) discard timer for any Service Data Unit (SDU) in an LCG falls below a threshold;
   a padding-based trigger when a number of padding bits in an UL resource allocation is sufficient for a BDSR Medium Access Control Element (MAC CE);
   a retransmission-based trigger when a retransmission BDSR timer expires and UL data is available in at least one logical channel of an LCG;
   a periodic trigger based on the expiration of a periodic BDSR timer;
electing one of a plurality of BDSR formats based on the triggering conditions, the formats including a Short BDSR format, a Long BDSR format, and a Truncated BDSR format;
transmitting the BDSR via an uplink shared channel (UL-SCH) when uplink resources are available; and
cancelling or postponing the transmission of the BDSR when uplink resources are insufficient for the BDSR transmission.

### BRIEF DESCRIPTION OF THE DRAWINGS

FIG. 1: depicts BDSR Triggering Mechanism.

FIG. 2: depicts Performance Comparison

FIG. 3: Conceptual representation of Hardware changes of gNB and UE

### DETAILED DESCRIPTION OF THE INVENTION

The invention, known as the Buffer and Delay Status Reporting (BDSR) mechanism, is an advanced system designed to optimize uplink scheduling and resource allocation in wireless networks. The BDSR mechanism integrates key components and processes that collectively improve the efficiency of data transmission, reduce signaling overhead, and enhance support for delay-sensitive applications. The following description outlines the working model, system architecture, and performance evaluation of the BDSR mechanism.

### BDSR Triggering Mechanism:

The BDSR is triggered under various conditions, ensuring that reports are generated only when necessary. The triggering conditions include:

### 1. Regular BDSR Trigger:

When uplink (UL) data becomes available for a logical channel belonging to a Logical Channel Group (LCG) configured for BDSR, and either:
a) This UL data belongs to a logical channel with higher priority than any logical channel containing available UL data in any LCG, or
b) None of the logical channels belonging to any LCG contains available UL data.

### 2. Delay-Based Trigger:

When the smallest remaining value of the running PDCP (Packet Data Convergence Protocol) discard Timers among all SDUs (Service Data Units) buffered for an LCG configured for BDSR becomes less than the remaining time Threshold, and there is no BDSR pending for this LCG.

### 3. Padding-Based Trigger:

When UL resources are allocated, and the number of padding bits is equal to or larger than the size of the BDSR MAC CE (Medium Access Control Element) plus its sub header.

### 4. Retransmission-Based Trigger:

When the retxBDSR-Timer expires, and at least one of the logical channels belonging to an LCG configured for BDSR contains UL data.

### 5. Periodic Trigger:

When the periodic BDSR-Timer expires.

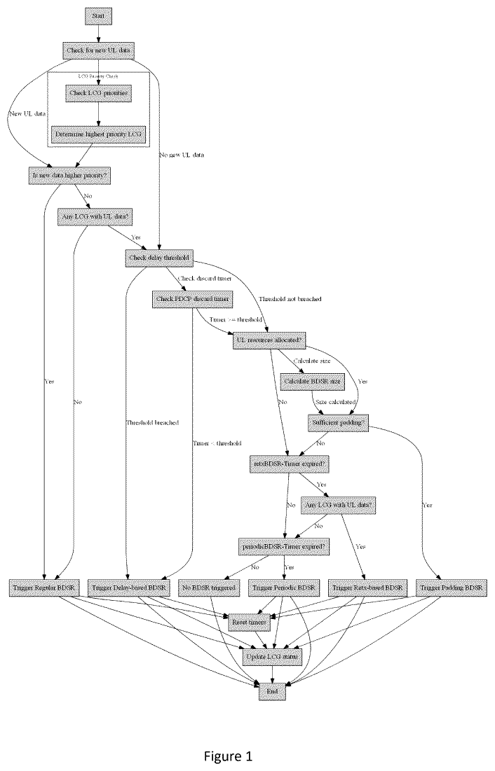

The flowchart of BDSR triggering mechanism is shown in FIG. 1.

### BDSR Formats:

The BDSR mechanism introduces three formats to cater to different reporting needs and resource availability:

1. Short BDSR Format (15 bits):
Used for reporting a single Logical Channel Group (LCG)
F: Format indicator (set to 0 for Short BDSR)
LCG ID: Identifies the Logical Channel Group (3 bits)
Buffer Size: Reports the amount of data available (5 bits)
Remaining Time: Indicates the shortest remaining PDCP discard timer value (6 bits)

Short BDSR Format

| | | | |
|---|---|---|---|
| F | LCG ID | Buffer Size | Remaining Time |

F: Format (0 for Short BDSR)
LCG ID: 3 bits
Butter Size: 5 hits
Remaining Time: 6 bits
   2. Long BDSR Format (variable size):
Used for reporting multiple LCGs
F: Format indicator (set to 1 for Long BDSR)
LCG Indicators: Bitmap indicating which LCGs are reported (8 bits)
Number of LCGs: Count of reported LCGs (3 bits)
BT: Buffer Table indicator for interpreting Buffer Size (1 bit)
Buffer Size: Reports the amount of data available (8 bits)
Remaining Time: Indicates the shortest remaining PDCP discard timer value (6 bits)
The {BT|Buffer Size|Remaining Time} group is repeated for each reported LCG

Long BDSR Format

| F | LCG Indicators | Number of LCGs |
|---|---|---|
| BT | Buffer Size 1 | Remaining Time 1 |
| BT | Buffer Size 2 | Remaining Time 2 |

F: Format (1 for Long BDSR)
LCG Indicators: Bits indicating which LCGs are reported
BT: Buffer Table Indicator
Buffer Size: 8 bits, Remaining Time: 6 bits for each reported LCG

### 3. Truncated BDSR Format (Variable Size):

Similar structure to Long BDSR, but may include fewer LCGs due to space constraints
Used when padding bits are available but insufficient for a full Long BDS

### Truncated BDSR Format

| F | LCG Indicators | Number of LCGs |
|---|---|---|
| BT | Buffer Size 1 | Remaining Time 1 |

. . .
Partial information for last LCG

Similar to Long BDSR, but may not include all LCGs
Used when padding bits are available
but not enough for full Long BDSR

### BDSR Fields:

F (Format): Indicates whether the BDSR is in Short (0) or Long/Truncated (1) format
LCG ID: Identifies the specific Logical Channel Group being reported
Buffer Size: Represents the total amount of data available for the corresponding LCG
Remaining Time: Indicates the shortest remaining value of running PDCP discard Timer among all SDUs buffered for the LCG
LCG Indicators: A bitmap where each bit corresponds to an LCG, indicating which LCGs are reported in the BDSR
Number of LCGs: Specifies the number of LCGs reported in the BDSR
BT (Buffer Table): Indicates which buffer size table is used for interpreting the Buffer Size field

### BDSR Processing:

### 1. Generation:

The MAC entity determines the appropriate BDSR format based on the number of LCGs to report and available UL resources
For Long and Truncated formats, LCGs are reported in ascending order of LCG ID

### 2. Transmission:

If UL-SCH (Uplink Shared Channel) resources are available and can accommodate the BDSR MAC CE plus its sub header:
   The MAC entity instructs the Multiplexing and Assembly procedure to generate the BDSR MAC CE
   The periodic BDSR-Timer and retxBDSR-Timer are started or restarted
If resources are not available, a Scheduling Request may be triggered

### 3. Cancellation:

Triggered BDSRs may be cancelled when:
   The UL grant can accommodate all pending data but not the BDSR MAC CE
   A MAC PDU is transmitted including a Long BDSR MAC CE containing buffer status up to the last triggering event

### 4. Handling Multiple Triggers:

If multiple BDSR triggering conditions are met simultaneously, only one BDSR shall be included in a MAC PDU
Regular and Periodic BDSRs take precedence over Padding BDSRs

### Performance Evaluation:

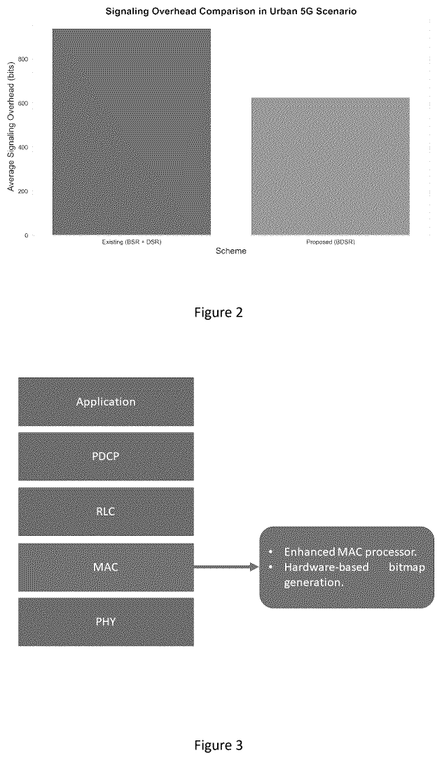

The following FIG. 2 shows the performance gain in terms of reduced signalling overhead compared to the existing scheme.

### Hardware Modifications:

To implement the BDSR mechanism, specific hardware enhancements are required both in the User Equipment (UE) and the gNB (Next Generation Node B):
Enhanced MAC Processor:
   The UE requires an upgraded MAC processor to handle the new BDSR triggering logic, support the three BDSR formats (Short, Long, Truncated), and implement adaptive triggering based on various factors.
Modified Timer Hardware:
   Hardware modifications are necessary to support real-time comparisons with the remaining Time Threshold, enabling precise delay-based triggering.
Buffer Modifications:
   The UE and gNB systems require adjustments in buffer management to enable unified reporting across LCGs. The use of hardware-based bitmap generation for LCG Indicators may be employed to enhance processing performance.

Thus, the Buffer and Delay Status Reporting (BDSR) mechanism offers several key advantages over existing reporting systems. By unifying Buffer Status Reports (BSRs) and Delay Status Reports (DSRs) into a single, cohesive framework, the BDSR mechanism eliminates redundant signaling, significantly reducing overhead and improving network efficiency. The adaptive triggering feature ensures that reports are generated only when necessary, optimizing resource usage and further minimizing unnecessary transmissions. The flexibility provided by multiple BDSR formats (Short, Long, and Truncated) allows for efficient use of radio resources under varying network conditions, ensuring that the reporting mechanism adapts to the needs of the network without compromising performance. Additionally, the simultaneous reporting of buffer size and delay information enables more informed and precise uplink scheduling, which reduces latency and enhances the support for delay-sensitive applications.

These advantages collectively lead to improved network performance, better resource allocation, and a higher quality of service in next-generation wireless networks.

### Advantages

The unique features of the Buffer and Delay Status Reporting (BDSR) mechanism demonstrate a clear inventive step over existing technologies. The unification of Buffer Status Reports (BSRs) and Delay Status Reports (DSRs) into a single reporting framework addresses longstanding inefficiencies in 5G networks, particularly the redundancy and overhead associated with separate reporting mechanisms. The introduction of adaptive triggering, which dynamically adjusts to data availability, delay thresholds, and resource conditions, represents a significant improvement in signaling efficiency and resource management. Additionally, the flexible BDSR formats, including Short, Long, and Truncated options, offer a tailored approach to various reporting scenarios, optimizing the use of radio resources. These innovations collectively provide a more comprehensive and efficient solution for uplink scheduling and resource allocation, addressing the complex demands of next-generation networks. The combination of these features, particularly in their ability to reduce latency and improve network performance, demonstrates a level of inventiveness that significantly advances the state of the art in wireless communication.

The uniqueness and constitutional specialty is associated with other advantages given as follows:
Unified Buffer and Delay Status Reporting (BDSR) mechanism that consolidates BSR and DSR into a single reporting framework. This employs simultaneous reporting of buffer size and remaining time for LCGs to enhance scheduling accuracy.
Adaptive triggering mechanism based on multiple factors such as data availability, delay thresholds, and resource allocation priorities. Additionally, dynamic BDSR processing rules for generation, transmission, and cancellation, adapting to changing network conditions.
Introduction of three distinct BDSR formats (Short, Long, and Truncated) to cater to varying reporting needs and resource availability.
Hardware modifications for enhanced MAC processing, real-time timer comparison, unified buffer management across LCGs, hardware-based bitmap generation of LCG Indicators to optimize performance.

### APPLICATIONS

Uplink scheduling in 5G and beyond networks
IoT, XR, and autonomous systems requiring low-latency communication
Advanced network management software
Enhanced user equipment (UE) and telecommunications hardware

We claim:

1. A system for integrated single framework Buffer and Delay Status Reporting in wireless network-based communication comprising:
a user equipment (UE) configured to generate said integrated single framework Buffer and Delay Status Reports (BDSRs) in MAC layer;
MAC Processor in the UE configured to generate the BDSRs based on triggering logic and implementing adaptive triggering based on anyone or more of (i) regular BDSR trigger, (ii) delay-based trigger, (iii), padding-based trigger, (iv) retransmission-based trigger and (v) periodic trigger;
timer to support real-time comparisons with remaining time threshold, enabling precise delay-based triggering;
network node cooperative to said UE for adjustments in buffer management to enable unified reporting across Logical Channel Group (LCG) configured for the BDSRs.

2. The system as claimed in claim 1, wherein the MAC Processor implements the regular BDSR trigger when uplink (UL) data in the wireless network-based communication becomes available for a logical channel belonging to a Logical Channel Group (LCG) configured for the BDSR, and either this UL data belongs to a logical channel with higher priority than any logical channel containing available UL data in any LCG or none of the logical channels belonging to any LCG contains available UL data;
wherein the MAC Processor implements the delay-based trigger when smallest remaining value of running PDCP (Packet Data Convergence Protocol) discard timers among all SDUs (Service Data Units) buffered for an LCG configured for the BDSR becomes less than the remaining time threshold, and there is no BDSR pending for this LCG;
wherein the MAC Processor implements the padding-based trigger when UL resources are allocated, and the number of padding bits is equal to or larger than the size of the BDSR MAC CE (Medium Access Control Element) plus its sub header;
wherein the MAC Processor implements the retransmission-based trigger when retx BDSR-timer expires, and at least one of the logical channels belonging to an LCG configured for BDSR contains UL data; and
wherein the MAC Processor implements the periodic trigger when the periodic BDSR-timer expires.

3. The system as claimed in claim 1, wherein the BDSR includes a short format or a long format or a truncated format to cater to different reporting needs and resource availability.

4. The system as claimed in claim 1, wherein the BDSR format includes
Format indicator which indicates whether the BDSR is in short (0) or long/truncated (1) format;
LCG ID that identifies the specific Logical Channel Group being reported;
buffer size that represents the total amount of data available for the corresponding LCG;
remaining time that indicates the shortest remaining value of running PDCP discard Timer among all SDUs buffered for the LCG;
LCG indicators which is a bitmap where each bit corresponds to an LCG, indicating which LCGs are reported in the BDSR;
number of LCGs which specifies the number of LCGs reported in the BDSR;
BT (Buffer Table) which indicates which buffer size table is used for interpreting the Buffer Size field.

5. The system as claimed in claim 1, wherein the MAC layer determines the appropriate BDSR format based on the number of LCGs to report and available UL resources, whereby for long and truncated formats, the LCGs are reported in ascending order of the LCG ID.

6. The system as claimed in claim 1, wherein the MAC layer instructs Multiplexing and Assembly procedure to generate BDSR MAC CE which corresponds to BDSR-buffer and delay status report generated as a control element (CE) at the MAC layer for transmission, if UL-SCH (Uplink Shared Channel) resources are available and can accommodate the BDSR MAC CE plus its sub header and if resources are not available, then a scheduling request is triggered;
wherein the triggered BDSRs are cancelled when the UL grant can accommodate all pending data but not the BDSR MAC CE and a MAC PDU is transmitted including a Long BDSR MAC CE containing buffer status up to the last triggering event.

7. A method for enhancing uplink scheduling and resource allocation in a wireless network involving the system as claimed in claim 1 comprising:
receiving data for one or more logical channel groups (LCGs) configured for said BDSR;
triggering the generation of a particular BDSR based on the triggering conditions, including:
a regular BDSR trigger based on the availability of uplink (UL) data for a logical channel of an LCG;
a delay-based trigger when the smallest remaining time of a Packet Data Convergence Protocol (PDCP) discard timer for any Service Data Unit (SDU) in an LCG falls below a threshold;
a padding-based trigger when a number of padding bits in an UL resource allocation is sufficient for a BDSR Medium Access Control Element (MAC CE);
a retransmission-based trigger when a retransmission BDSR timer expires and UL data is available in at least one logical channel of an LCG;
a periodic trigger based on the expiration of a periodic BDSR timer;
electing one of a plurality of BDSR formats based on the triggering conditions, the formats including a Short BDSR format, a Long BDSR format, and a Truncated BDSR format;
transmitting the BDSR via an uplink shared channel (UL-SCH) when uplink resources are available; and
cancelling or postponing the transmission of the BDSR when uplink resources are insufficient for the BDSR transmission.
